(19) United States
(12) Patent Application Publication
(10) Pub. No.: US 2005/0262049 A1
(43) Pub. Date: Nov. 24, 2005

(54) System, method, device, and computer code product for implementing an XML template

(75) Inventor: Ville Somppi, Tampere (FI)

Correspondence Address: FOLEY & LARDNER, 321 NORTH CLARK STREET, SUITE 2800, CHICAGO, IL, 60610-4764, US

(73) Assignee: Nokia Corporation

(21) Appl. No.: 10/840,392

(22) Filed: May 5, 2004

(51) Int. Cl. G06F 7/00

(52) U.S. Cl. 707/3

(57) ABSTRACT

A system, method, device, and computer code product for implementing an XML template having user-defined keywords is disclosed. Embodiments of the invention can be configured to identify user-defined keyword definitions in the XML template, identify the user-defined keywords in the XML template, replace the user-defined keywords with user-defined data, and removed the user-defined keyword definitions to form a usable XML document.

### FIELD OF THE INVENTION

The present invention relates generally to the field of XML documents. More particularly, the present invention relates to systems, methods, devices and computer code products for generating XML documents from templates having user-defined keywords.

### BACKGROUND OF THE INVENTION

Many different formats can be used to describe the content of a file. One such format is eXtensible Markup Language (XML). XML is a standard protocol for exchanging data between distributed applications or layers of the same application in a database system. XML is used widely in software for describing structured data. XML is designed to provide flexible and adaptable information formatting and identification. XML is called extensible because it has no fixed format like the Hypertext Markup Language (HTML), which is a set of defined markups. An XML file uses markup symbols to describe the content of the file in terms of the type of data it contains. These markup symbols are unlimited and self-defining. An XML file can be processed purely as data to be stored, or it can be displayed or acted upon in any number of ways. XML is similar to a meta-language (a language for describing other languages), which allows users to design customized markup languages for many different types of documents.

One of XML's principal purposes is structuring data. Structured data includes things like spreadsheets, address books, configuration parameters, financial transactions, and technical drawings, to name a few. XML includes a set of rules for designing text formats that support structuring data. Like HTML, XML makes use of elements, keywords, and attributes. Elements are content segments identified by keywords. Elements have possibly have empty values, the value of an instance of an element being the string between the start-keyword and end-keyword for the instance of the element. Keyword are tags bracketed by ‘<’ and ‘>,’ and attributes are defined characteristics of elements.

While HTML specifies what each keyword and attribute means, and often how the text between them will look in, for example, an Internet browser, XML uses the tags only to delimit pieces of data and leaves the interpretation of the data completely to the application that reads it. In other words, although in the predefined syntax of HTML, “<p>” means paragraph, “<p>” in an XML file means whatever the reading application says it means. Depending on the context, it may be a price, a parameter, a person, or anything else the reading application interprets it to be. Unlike HTML, XML itself does not have formatting elements. Additional documents, called stylesheets, typically dictate how an XML document will appear in print or on a computer screen. Placing all display formatting in separate files means that display appearance can be changed for all compliant XML documents with no need to edit the XML documents themselves.

When applications use XML to describe data, they will declare a vocabulary for the application. This vocabulary is typically described in the form of a document type definition (DTD) or an XML Schema. Examples of XML vocabularies are eXtensible HyperText Markup Language (XHTML), which is a particular application of XML for the expression of Web pages, Synchronized Multimedia Integration Language (SMIL), which can be used to define and synchronize multimedia elements, such as video, audio, and/or still images for Web presentation and interaction, and XPath, which can be used to describe a way to locate and process items in an XML document. There are thousands of DTDs already in existence for many subjects. The vocabulary typically defines what keywords (elements, attributes, etc.) are allowed in the XML documents conforming to the application's document type. XML documents can be used in many different applications and settings. One common application is to use an XML document to describe a webpage which can be viewed on a computer running an Internet browser.

In recent years there has been a proliferation of portable electronic devices such as mobile telephones, personal digital assistants, and other mobile electronic devices. These mobile devices offer a range of capabilities, including mobile calendars, organizing capabilities, electronic mail, document creation/preparation, image creation/capture, photograph creation/capture, etc. Another application of XML involves using wireless technology to print a document or file that was created or stored on the mobile device. Mobile devices can be equipped to communicate with printers using wireless communication technology. For example, Bluetooth wireless technology may be used to enable a mobile device to communicate with a Bluetooth enabled printer. Bluetooth Basic Printing Profile (BPP) may be used to facilitate wireless printing from mobile devices having minimal resources, such as mobile phones that do not have the memory or CPU power to efficiently support the traditional desktop printing model. BPP is a specification defining methods for driverless printing over Bluetooth. BPP offers the user a simple printing experience that takes advantage of the ease in configuring wireless communications based on Bluetooth wireless technology and XHTML page formatting. However, BPP mandates only one page description language, XHTML-Print. This means that any data the mobile device wants to print must be converted to XHTML-Print format in order to take advantage of BPP.

There are many other sample applications of this technology as well. For example, both Microsoft™ Word™ and Open Office™ use the XML file format. As such, XML templates with keywords can be defined for and used with either of these software application programs. In addition, Simple Object Access Protocol (SOAP) messages use the XML format, so XML templates with keywords can be defined and used for producing SOAP messages. These are just a few of the many possible applications of XML templates with keywords. It should be understood that many other applications can be made of XML templates with keywords without departing form the spirit and scope of the invention.

One problem with XML is that if the document contains keywords that are not part of the vocabulary, the document is not valid. As such, any application that creates or edits XML documents must follow the specific (mandated) vocabulary. In some instances, it is beneficial to define an XML template that can be used to format similar documents to look alike. It might also be helpful if there were a way to configure the template to incorporate some user or device defined dynamic information by using user-defined keywords that are not defined in the DTD or XML Schema vocabulary. For example, it may prove useful to incorporate dynamic information such as dates and times in printable XML templates of the type described above. However, problems can arise if the XML vocabulary does not support these user-defined keywords. In the wireless printing example discussed above, the XML parser on the device reading the XML file (i.e. the printer) may not understand the user-defined keywords and the document will be declared invalid.

As such, there is a need for an improved method, system, device and computer code product for incorporating user-defined keywords into XML templates. There is also a need for an improved method, system, device and computer code product for generating XML documents from templates having user-defined keywords.

### SUMMARY OF THE INVENTION

Various embodiments of the invention relate to methods, systems, devices, and computer code products for implementing user-defined information in an XML template. One embodiment of the invention includes a method, system, device and/or computer code product for converting an XML template including user-defined keywords into a usable XML document. The method can include identifying user-defined keyword definitions in the XML template, identifying user-defined keywords in the XML template, replacing the user-defined keywords with data corresponding to the user-defined keywords, and removing the user-defined keyword definitions from the XML template. Replacing the user-defined keywords with data further can include accessing a user-defined information database to obtain data corresponding to the user-defined keywords. The user-defined information database can be defined as an element whose name is a keyword in the XML template. The database can be searched in various ways including searching based on a keyword name or a location. The user-defined keyword definitions can be included within a predefined element of the XML template.

Another embodiment of the invention includes a system for printing a document. The system can comprise an XML template having XML code for describing the document to be printed in terms of the type of data the document contains. The XML template may also include user-defined keywords for specifying user-defined information. The system can also include a conversion routine for converting the XML template into a usable XML document and an XML parser for parsing the usable XML document and converting it into a printable document. The conversion routine can be configured to identify the user-defined keyword definitions, identify the user-defined keywords, replace the user-defined keywords with data corresponding to the keywords, and delete the user-defined keyword definitions to convert the XML template into a usable XML document.

The system can also include a database of user-defined information wherein the conversion routine is configured to access the database to look up the data corresponding to the user-defined keywords. The XML template and conversion routine, along with a wireless transmitter can be included in a mobile device. The XML parser, along with a wireless receiver, can be included in a printer. The mobile device can be configured to transmit the usable XML document to the printer and the printer can be configured to receive and print the usable XML document. The wireless transmitter and wireless receiver can be configured to use, among other technologies, Bluetooth wireless technology.

Another embodiment of the invention can include a computer code product comprising an XML template. The XML template can include XML code for describing a document in terms of the type of data the document contains and at least one user-defined keyword for specifying user-defined information. The XML template can also include at least one user-defined keyword definition for defining the user-defined keyword. The user-defined keyword can be defined as an element whose name is a keyword and the user-defined keyword definition can be included within a predefined element in the XML template.

Other principle features and advantages of the invention will become apparent to those skilled in the art upon review of the following drawings, the detailed description, and the appended claims.

### BRIEF DESCRIPTION OF THE DRAWING

Exemplary embodiments will hereafter be described with reference to the accompanying drawings.

FIG. 1 is a block diagram of one embodiment of a system for converting an XML template into a usable XML document;

FIG. 2 is a block diagram of one embodiment of a system for implementing user defined information in an XML template;

FIG. 3 is a flow chart illustrating one embodiment of a method for converting an XML template including user-defined keywords into a usable XML document;

FIG. 4 is one embodiment of a sample XML template having user-defined keywords according to the present invention; and

FIG. 5 is one embodiment of a sample usable XML document produced from the sample XML template of FIG. 4 in accordance with one embodiment of the present invention.

### DETAILED DESCRIPTION OF THE PREFERRED EMBODIMENTS

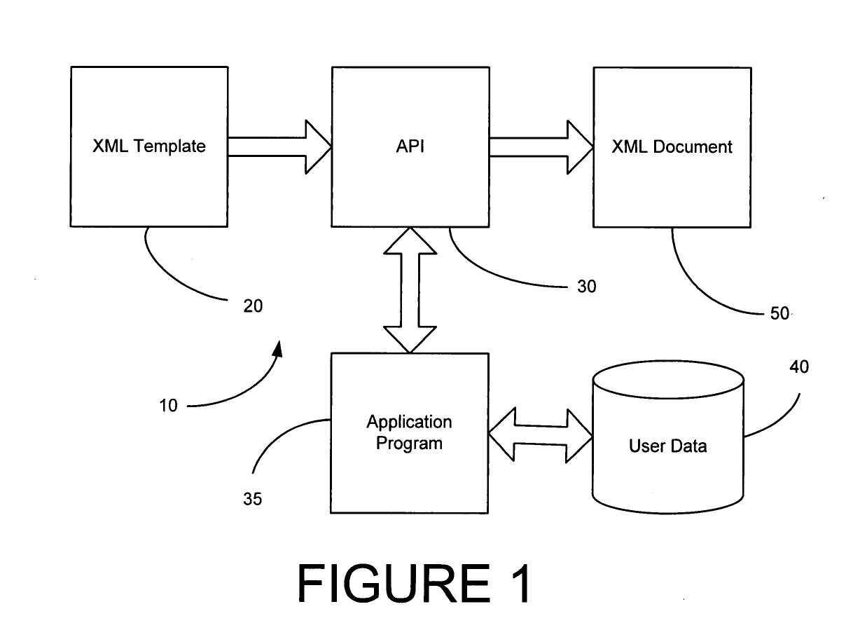

Embodiments of the present invention present methods, systems, devices, and computer code products for implementing user-defined information in an XML template. Referring to FIG. 1, a system 10 for converting an XML template 20 into a usable XML document 50 is shown. The system 10 includes an Application Program Interface (API) 30, an application program 35, and a database 40 of user data. The API 30 is a formalized set of software calls and routines that can be referenced by the application program 35 in order to convert the XML template 20 into the XML document 50. APIs in general can be used to access the supporting system or network services. An API can be the specific method prescribed by a computer operating system or by an application program by which a programmer in writing an application program makes requests of the operating system or of another application program. An API generally can also receive requests from the operating system or another application program and route these requests to the appropriate application program.

In the embodiment shown in FIG. 1, API 30 acts as a conversion engine for converting an XML template 20 into a usable XML document 50. The embodiments of the invention disclosed and described herein allow a user to incorporate user-keywords and dynamic information into the same XML template program code used to define the display format of the resulting XML document 50. The term user, as used herein, is meant to include any device, owner, manufacturer, application designer, template designer, etc. capable of defining keywords or the corresponding data.

In operation, the application program 35 can ask the API 30 to open an XML template 20. The API 30 can be configured to open the XML template 20, identify any user-defined keyword definitions, and collect the names of user-defined keywords for later use. The API 30 can also be configured to perform other predefined and automated tasks. Once the XML template 20 has been opened, the application program 35 can collect user data or information from the database 40 and pass that data on to the API 30 with instructions to replace the keyword with the user data.

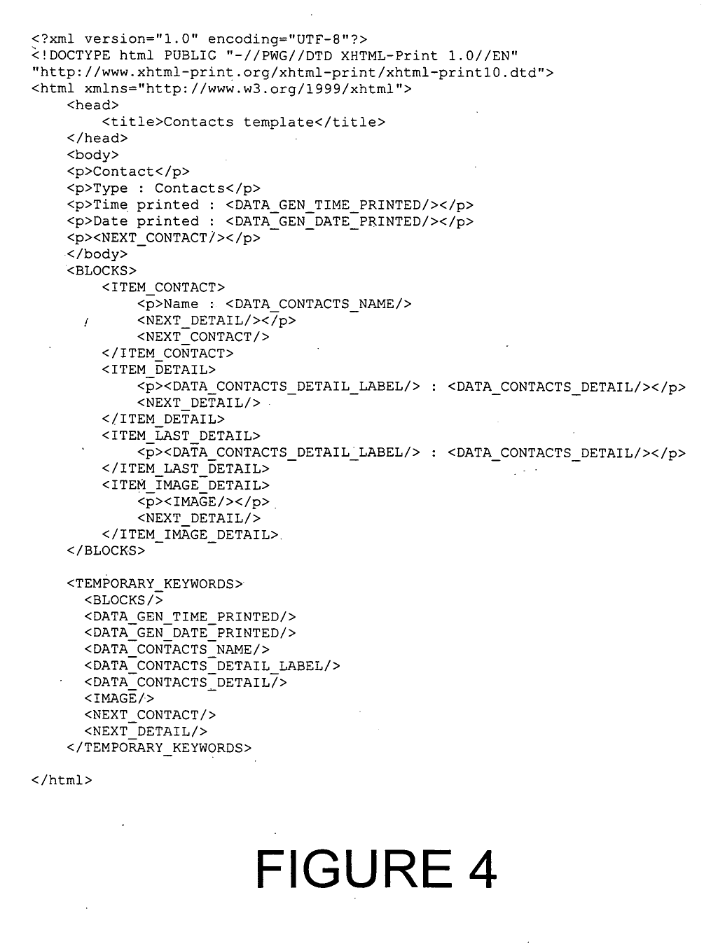

The API 30 can replace the keyword with the user data, and this process can be repeated by the application program 35 until all available data is sent to the API 30 for replacement of keywords. If the XML template 20 contains repeatable block of data (e.g. multiple contacts in a contacts program), the application program 35 can ask the API 30 to duplicate user-defined blocks of data (the blocks can also be defined as keywords in the XML template). The API 30 can be configured use the keywords for the source (eg. FIG. 4 <ITEM_CONTACT>) and target (eg. FIG. 4 <NEXT_CONTACT>) to duplicate the user-defined blocks of data.

Once all of the available data has been filled into the XML template 20, the application program 35 can ask the API 30 to close the template 20 and write the resulting XML document 50 into a file. The API 30 can be configured to identify keywords remaining the in the XML document 50 (from the keyword names collected upon opening of the XML template 20) and remove them from the XML document 50 before saving it. This can also include removing any data contained inside keyword elements.

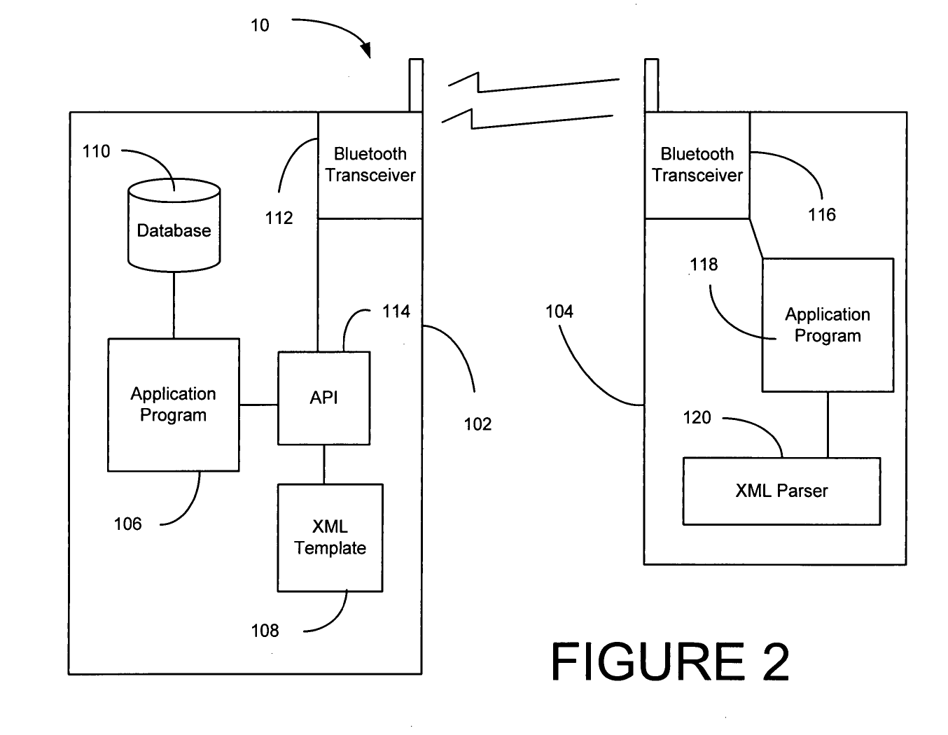

One embodiment of a system implementing user-defined information in an XML template is shown in FIG. 2. The system 100 illustrated in FIG. 2 is configured for sending files from a mobile device 102 to a printer 104 for printing. The mobile device 102 can comprise a wireless communication device such as a mobile telephone or personal digital assistant. The mobile device 102 includes an application program 106, such as, for example in this case, a contacts management software application. An XML template 108 included on the mobile device 102 can be set up to format individual contact entries. The actual contact information can be included in a database 110. The mobile device 102 can be configured for wireless communications and, in this exemplary embodiment, includes a Bluetooth transceiver 112 for establishing wireless communication with a Bluetooth-enabled printer 104.

The application program 106 can be configured for creating, editing, maintaining, and printing individual and business contact information. In response to a print command, the application program 106 can be configured to use an API 114 for creating a printable XML document from an XML template 108. The application program 106 can call an API 114 to request that the API 114 open the XML template 108, which is setup with the desired printing format for the contact information. The API 114 can open the XML template 108 and identify and collect user-defined keywords included in the XML template 108. The application program 106 can then access a database 110 including user-defined information corresponding to the collected keywords. The application program 106 looks up user-defined information corresponding to the collected keywords in the database 110 and sends the user-defined information to the API 114. The API 114 can use this user-defined information to replace the corresponding keywords. This process can be repeated until all of the keywords have been replaced with user-defined information. The application program 106 can then use the API 114 to close the XML template 108 and create the usable XML document formed by replacing the collected keywords with user-defined information. Before creating the usable XML document, the API 114 can be configured to remove all keywords and keyword definitions from the document. The XML document created by the API 114 will be in the proper format for printing and the application program 106 can pass the XML file to the Bluetooth transceiver 112 for sending to the printer 104.

The printer 104 receives the XML file using its own Bluetooth transceiver 116. The transceiver 116 passes the XML file to an application program 118 in the printer 104 configured to control printing of documents. The application program 118 calls an XML parser 120 which parses the XML file and puts the file in the proper format for printing by the printer 104.

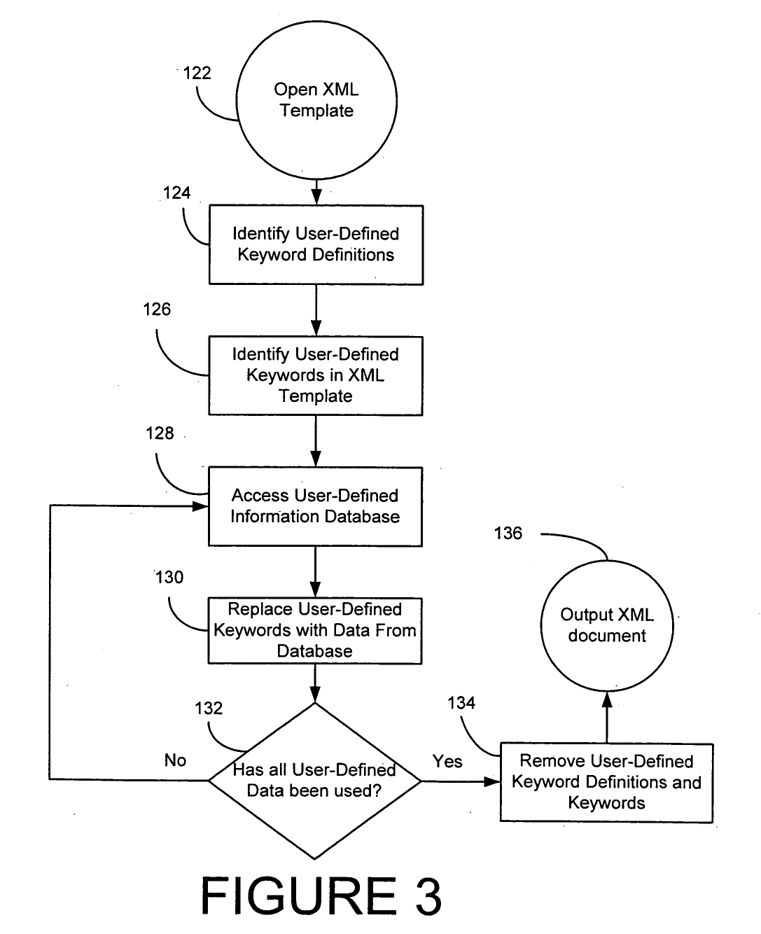

FIG. 3 illustrates one embodiment of a method for converting an XML template including user-defined keywords into a usable XML document. The XML template is opened 122, the user-defined keyword definitions are identified 124, and the user-defined keywords inside the template are identified 126 (preferably by an API) and can be stored for later use. A database of user-defined information can be accessed 128 (preferably by an application program) and the user-defined information corresponding to the keywords can be filled in in place of the keywords 130 (preferably by the API). A check can be performed to determine if all user-defined information has been used 132, and if not, the database can be accessed again 128 and more user-defined information can be filled in in place of keywords 103. After all of the user-defined information has been used, the keyword definitions and remaining keywords can be removed 134 (preferably by the API)and the resulting XML document can be outputted 136.

Preferably, the user-defined keywords are all defined within the XML template within a predefined element. For example, a “temporaryKeywords” element can be included in the XML template for defining the user-defined keywords. One sample syntax for predefined “temporaryKeywords” element can be:

<?xml . . .
<root>

<temporaryKeywords>

<keyword1>
<keyword2>

</temporaryKeywords>

The actual document <keyword1> using the keywords </keyword1><keyword2></root>

In one embodiment, the user-defined information database and keywords can be defined as elements whose name is the keyword. The database could be searched based on name (static or user-defined) or location (i.e. “first child of the root element”). FIG. 4 illustrates one sample embodiment of an XML template for a contacts application program. The XML template includes the user-defined keywords:

BLOCKS
LOC
DATA_GEN_TIME_PRINTED
DATA_GEN_DATE_PRINTED
DATA_CONTACTS_NAME
DATA_CONTACTS_DETAIL_LABEL
DATA_CONTENTS_DETAIL
IMAGE
NEXT_CONTACT
NEXT_DETAIL

The temporary keywords are defined in an element named “TEMPORARY_KEYWORDS.” The body of the XML template includes the DATA_GEN_TIME_PRINTED, DATA_GEN_DATE_PRINTED and NEXT_CONTACT keywords as well as the text “Contact,” “Type: Contacts,” “Time printed:, and “Date printed:”. Blocks of repeatable data corresponding to contacts records from a contacts application are defined by the BLOCKS keyword.

All of the immediate children of the BLOCKS keyword are repeatable blocks. For example, referring to FIG. 4, the elements ITEM_CONTACT, ITEM_DETAIL, ITEM_IMAGE_DETAIL, and ITEM_LAST_DETAIL are repeatable blocks. The idea is that all contacts include some redefined data (such as a name) and variable other information (such as some contacts may include a fax number, others may not). The application program uses the API to replace the keyword NEXT_CONTACT with the block ITEM_CONTACT and repeatedly replaces the NEXT_DETAIL block with ITEM_DETAIL (or ITEM_IMAGE_DETAIL or ITEM_LAST_DETAIL). The data keywords in ITEM_DETAIL are replaced with actual data such as the name or value of the detail. This procedure can be repeated as long as there is contact data. The ITEM_LAST_DETAIL element can be defined so that the NEXT_DETAIL element does not cause confusion when filing in multiple contacts.

For example, referring to FIG. 4, the initial state of the “body” section of the XML template is:

<body>

<p>Contact</p>
<p>Type : Contacts</p>
<p>Time printed : <DATA_GEN_TIME_PRINTED/></p>
<p>Date printed : <DATA_GEN_DATE_PRINTED/></p>
<p><NEXT_CONTACT/></p>

</body>

The NEXT_CONTACT element of the “body” section can be replaced with an ITEM_CONTACT block as follows:

<body>

<p>Contact</p>
<p>Type : Contacts</p>
<p>Time printed : <DATA_GEN_TIME_PRINTED/></p>
<p>Date printed : <DATA_GEN_DATE_PRINTED/></p>
<p>

<p>Name : <DATA_CONTACTS_NAME/>

<NEXT_DETAIL>

</p>
<NEXT_CONTACT>

</p>

</body>

Next, the DATA_CONTACTS_NAME element can be replaced with the user data “Doe, John” as follows:

<body>

<p>Contact/p>
<p>Type : Contacts</p>
<p>Time printed : <DATA_GEN_TIME_PRINTED/></p>
<p>Date printed : <DATA_GEN_DATE_PRINTED/></p>
<p>

<p>Name : Doe, John

<NEXT_DETAIL>

</p>
<NEXT_CONTACT>

</p>

</body>

The NEXT_DETAIL element can be replaced with an ITEM_IMAGE_DETAIL block as follows:

<body>

<p>Contact</p>
<p>Type : Contacts</p>
<p>Time printed : <DATA_GEN_TIME_PRINTED/></p>
<p>Date printed : <DATA_GEN_DATE_PRINTED/></p>
<p>

<p>Name : Doe, John

<p><IMAGE/></p>
<NEXT_DETAIL/>

</p>
<NEXT_CONTACT>

</p>

</body>

The IMAGE element can then be replaced with data as follows:

<body>

<p>Contact</p>
<p>Type: Contacts</p>

<p>Time printed : <DATA_GEN_TIME_PRINTED/></p>
<p>Date printed : <DATA_GEN_DATE_PRINTED/></p>
<p>

<p>Name : Doe, John

<p><img src=”c :\nokia\images\john.jpg” width=”100%” height =

”100%”</p>

<NEXT_DETAIL/>

</p>
<NEXT_CONTACT>

</p>

<body>

Next the NEXT_DETAIL element can be replaced with an ITEM_DETAIL block as follows:

<body>

<p>Contact</p>
<p>Type : Contacts</p>
<p>Time printed : <DATA_GEN_TIME_PRINTED/></p>
<p>Date printed : <DATA_GEN_DATE_PRTNTED/>/p>
<p>

<p>Name : Doe, John

<p><img src=”c:\nokia\images\john.jpg” width”100%” height =

”100%”</p>

<p><DATA_CONTACTS_DETAIL_LABEL/>:

<DATA_CONTACTS_DETAIL/></p>

<NEXT_DETAIL/>

</p>
<NEXT_CONTACT>

</p>

<body>

The DATA_CONTACTS_DETAIL_LABEL and DATA_CONTACTS_DETAIL elements can be replaced with data as follows:

<body>

<p>Contact<p>
<p>Type : Contacts</p>
<p>Time printed : <DATA_GEN_TIME_PRINTED/></p>
<p>Date printed : <DATA_GEN_DATE_PRINTED/></p>
<p>

<p>Name : Doe, John

<p><img src”c:\nokia\images\john.jpg” width=”100%” height=

”100%”</p>

<p>Phone : +358l23456789</p>
<NEXT_DETAIL/>

</p>
<NEXT_CONTACT>

</p>

</body>

an so on until all available user data has been sent to the API for replacement of keywords.

In many cases, the application program may require that all expected keywords are found somewhere in the XML template. However, in some situations, the user may want to omit some data corresponding to particular keywords from the usable XML document. It is possible to create “Omitted data” elements that include the keywords the user does not want included in the usable XML document. These keywords would be included as part of an “Omitted data” element so that they are part of the XML template and removed by the API before creating the usable XML document. In this situation, the “Omitted data” elements as well as the keywords included therein are treated similar to other elements and keywords in the template and are thus automatically removed by the API before outputting the usable XML document.

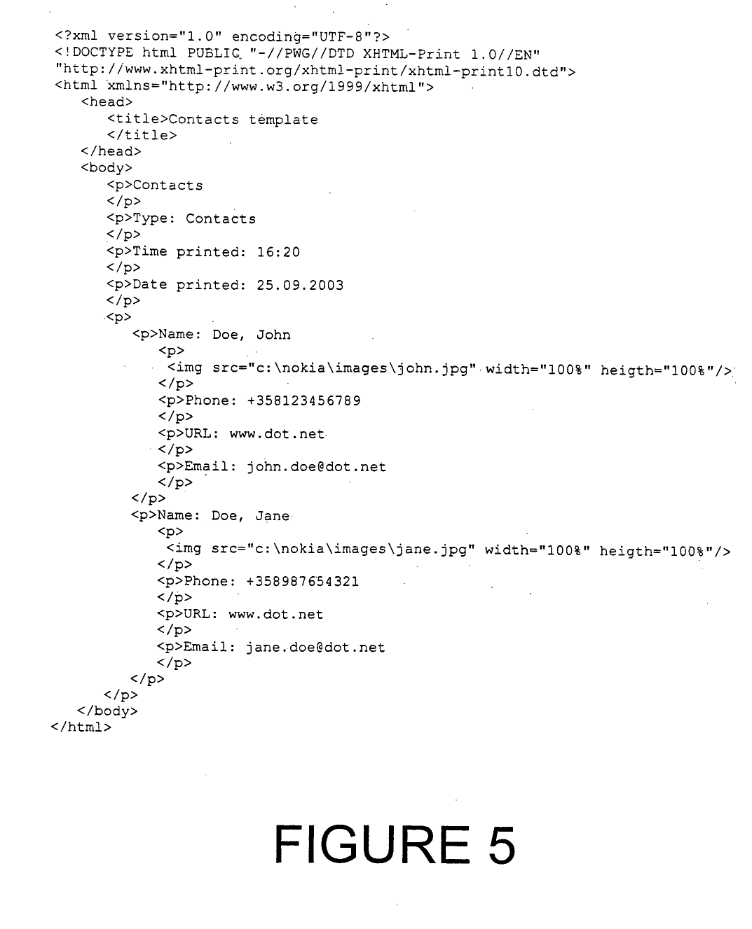

FIG. 5 illustrates one sample embodiment of an XML document prepared from the XML template of FIG. 4 in accordance with one embodiment of the present invention. As can be seen from FIG. 5, the DATA_GEN_TIME_PRINTED and DATA_GEN_DATE_PRINTED keywords are replaced with data “16:20” and “25.09.2003,” respectively. Two contacts records are shown as repeated data in FIG. 5 corresponding to BLOCKS element. The first contact record is for “John Doe” and the second for “Jane Doe.” Focusing on the first contact record, it can be seen that the DATA_CONTACTS_NAME keyword is replaced by the data “Doe, John.” The next entry corresponds to the IMAGE keyword from the ITEM_IMAGE_DETAIL element. As can be seen, a file location and name as well as display attributes replace the IMAGE keyword. The next three lines correspond to the ITEM_DETAIL and ITEM_LAST_DETAIL elements (two ITEM_DETAIL entries and one ITEM_LAST_DETAIL entry). Each line shows data replacing the DATA_CONTACTS_DETAIL_LABEL and DATA_CONTACTS_DETAIL keywords (such as “Phone,” “URL,” and “Email” for the former and “+358123456789,” “www.dot.net,” and “john.doe@dot.net” for the later). The second contact entry is configured in a similar manner.

The detailed description outlines exemplary embodiments of a method, device, system, and a computer program product for creating customizable XML templates and documents therefrom. In the foregoing description, for purposes of explanation, numerous specific details are set forth in order to provide a thorough understanding of the present invention. It is evident, however, to one skilled in the art that the exemplary embodiments may be practiced without theses specific details. In other instances, structures and devices are shown in block diagram form in order to facilitate description of the exemplary embodiments.

While the exemplary embodiments illustrated in the Figures and described above are presently preferred, it should be understood that these embodiments are offered by way of example only. Other embodiments may include, for example, different techniques for performing the same operations. The invention is not limited to a particular embodiment, but extends to various modifications, combinations, and permutations that nevertheless fall within the scope and spirit of the appended claims.

1. A method for converting an XML template including user-defined keywords into a usable XML document, the method comprising:
identifying user-defined keyword definitions in the XML template;
identifying user-defined keywords in the XML template;
replacing the user-defined keywords with data corresponding to the user-defined keywords; and
removing the user-defined keywords and user-defined keyword definitions from the XML template.

2. The method of claim 1, wherein replacing the user-defined keywords with data further comprises accessing a user-defined information database to obtain data corresponding to the user-defined keywords.

3. The method of claim 2, wherein the user-defined information database is defined as an element whose name is a keyword in the XML template.

4. The method of claim 2, wherein the user-defined information database can be searched based on a keyword name.

5. The method of claim 2, wherein the user-defined information database can be searched based on a location.

6. The method of claim 1, wherein the user-defined keyword definitions are all included within a predefined element of the XML template.

7. The method of claim 2, wherein accessing the user-defined information database is repeated until all keywords in the XML template have been replaced with data.

8. A device for converting an XML template including user-defined keywords into a usable XML document, the system comprising:
means for identifying user-device keyword definitions in the XML template;
means for identifying user-defined keywords in the XML template;
means for replacing the user-defined keywords with data corresponding to the user-defined keywords; and
means for removing the user-defined keyword definitions from the XML template.

9. The device of claim 8, wherein means for replacing the user-defined keywords with data further comprises a user-defined information database including data corresponding to the user-defined keywords and means for accessing the user-defined information database.

10. The device of claim 9, wherein the user-defined information database is defined as an element whose name is a keyword in the XML template.

11. The device of claim 9, further comprising means for searching the user-defined information database based on a keyword name.

12. The device of claim 9, further comprising means for searching the user-defined information database based on a location.

13. The device of claim 8, wherein the user-defined keyword definitions are all included within a predefined element of the XML template.

14. A system for a printing document, the system comprising:
an XML template including:
XML code for describing the document to be printed in terms of the type of data the document contains; and
user-defined keywords for specifying user-defined information;
a conversion routine for converting the XML template into a usable XML document;
an application program for calling the conversion routine; and
an XML parser for parsing the usable XML document and converting it into a printable document;
wherein the conversion routine is configured to identify the user-defined keyword definitions, identify the user-defined keywords, replace the user-defined keywords with data corresponding to the keywords, and delete the user-defined keyword definitions to convert the XML template into a usable XML document.

15. The system of claim 14 further comprising a database of user-defined information wherein the application program is configured to access the database to look up the data corresponding to the user-defined keywords.

16. The system of claim 14 further comprising a mobile device and a printer, the mobile device including:
the XML template;
the conversion routine;
the application program; and
a wireless transmitter; and
the printer including:
the XML parser; and
a wireless receiver;
wherein, the mobile device is configured to transmit the usable XML document to the printer and the printer is configured to receive and print the usable XML document.

17. The system of claim 16 wherein the wireless transmitter and wireless receiver are configured to use Bluetooth wireless technology.

18. A computer code product comprising:
computer code configured to:
identify user-defined keyword definitions in an XML template;
identify user-defined keywords in the XML template;
replace the user-defined keywords with data corresponding to the user-defined keywords; and
remove the user-defined keyword definitions from the XML template to produce a usable XML document.

19. A computer code product comprising:
an XML template including:
XML code for describing a document in terms of the type of data the document contains;
at least one user-defined keyword for specifying user-defined information.

20. The computer code product of claim 19 wherein the XML template further includes at least one user-defined keyword definition for defining the at least one user-defined keyword.

21. The computer code product of claim 19 wherein the at least one user-defined keyword is defined as an element whose name is a keyword.

22. The computer code product of claim 20 wherein the at least one user-defined keyword definition is included within a predefined element in the XML template.
